(19) United States
(12) Patent Application Publication
(10) Pub. No.: US 2005/0039122 A1
(43) Pub. Date: Feb. 17, 2005

(54) Methodology and system for rendering dynamic images

(76) Inventor: Michael Darren Meadows, Littleton, CO (US)

Correspondence Address: Michael D. Meadows, Building D, 44 Inverness Drive East, Englewood, CO, 80112, US

(21) Appl. No.: 10/633,510

(22) Filed: Aug. 5, 2003

(51) Int. Cl. G09G 5/00; G06F 17/00

(52) U.S. Cl. 715/523; 715/540; 715/542; 715/526; 715/530; 715/522; 715/524

(57) ABSTRACT

Problems inherent to this field of endeavor are 1) once a document is created, it cannot be presented in different fonts, colors, and/or languages, unless a copy of it is made, the desired changes in fonts, colors, and/or languages are applied to the copy, and the copy is saved as a separate entity, 2) the time and effort required to display documents in different fonts, colors, and/or languages erodes the value, and 3) applications that use documents are thereby limited.

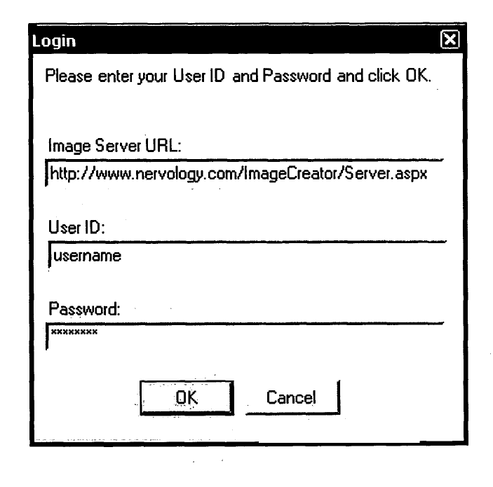

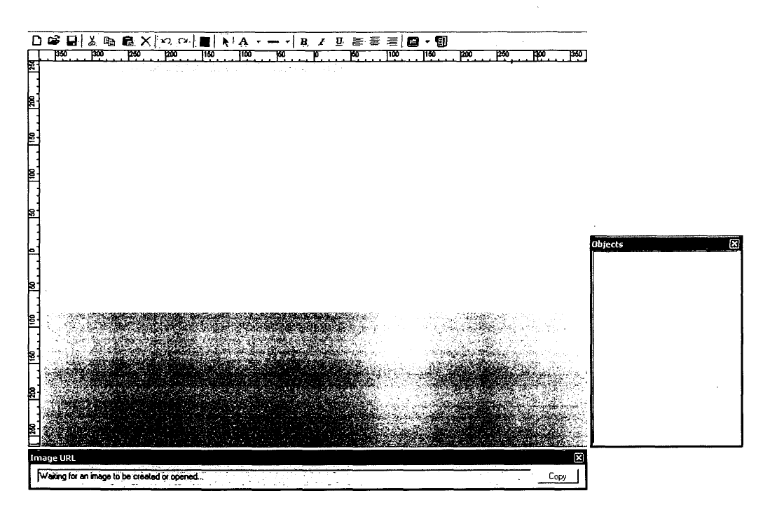

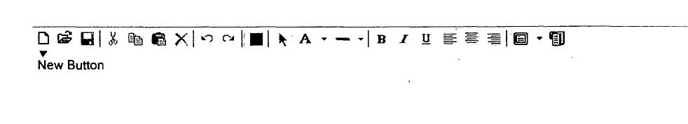

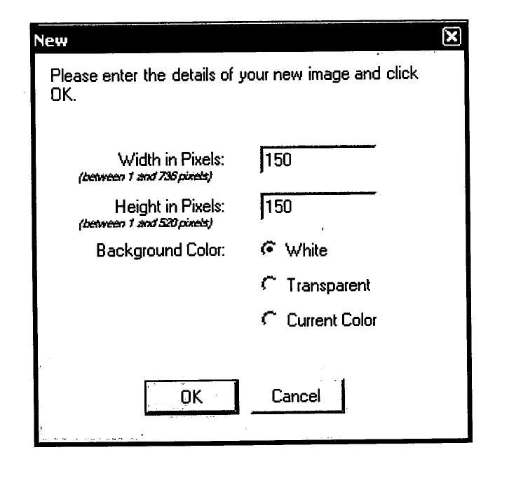

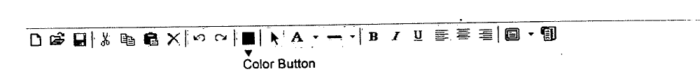

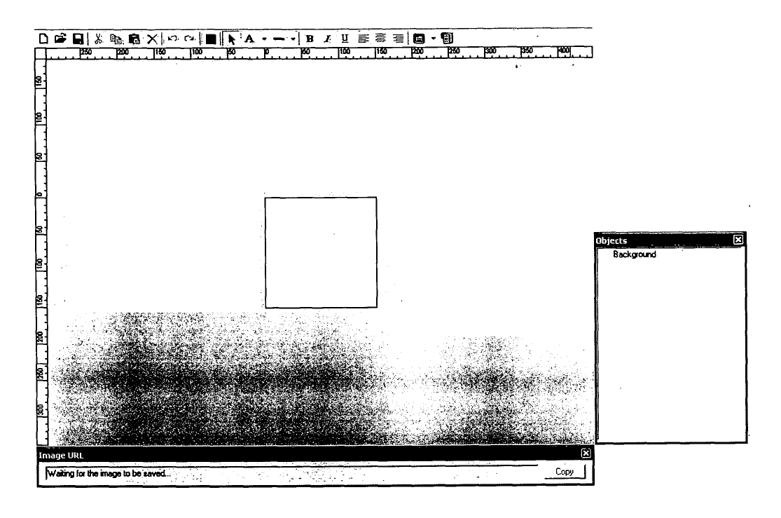

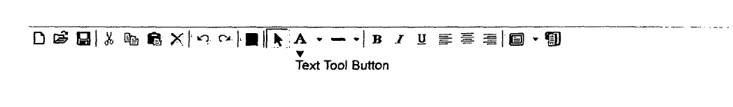

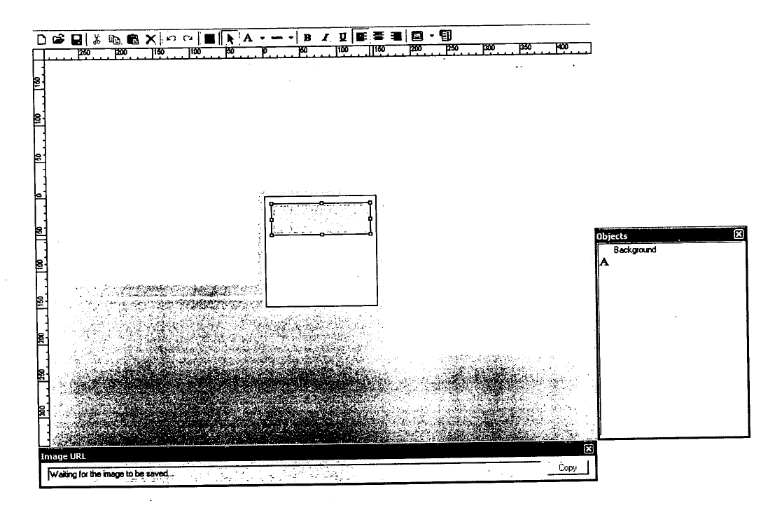

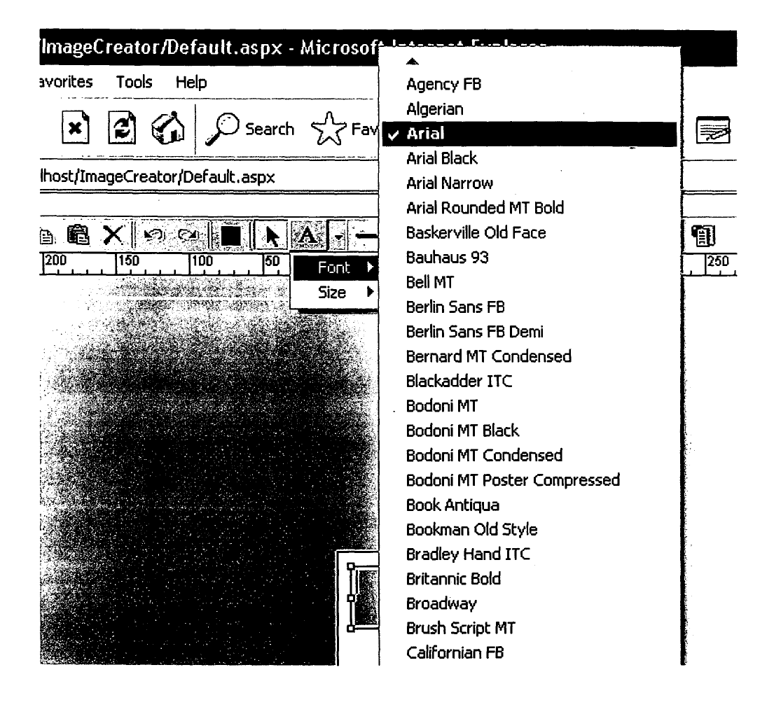

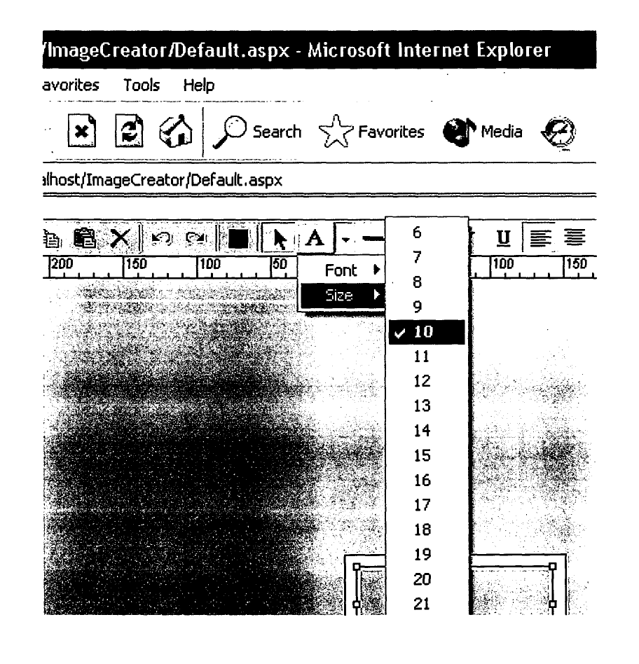

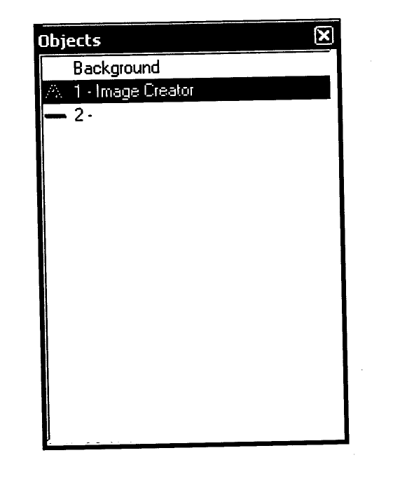

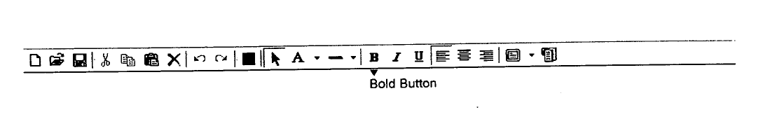

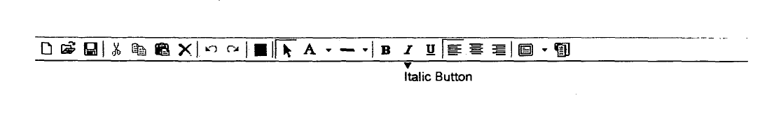

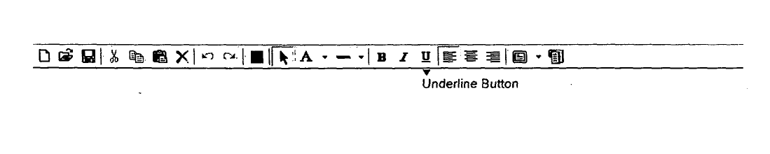

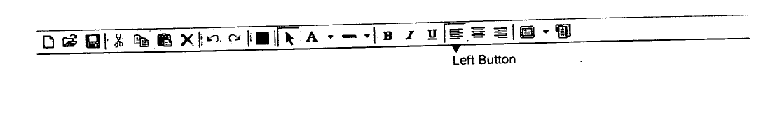

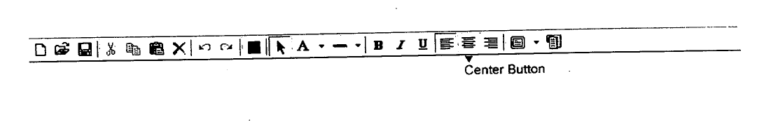

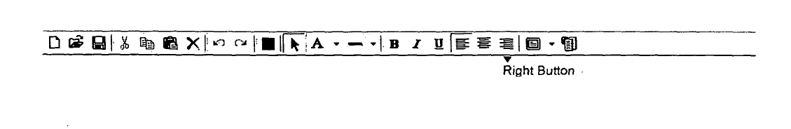

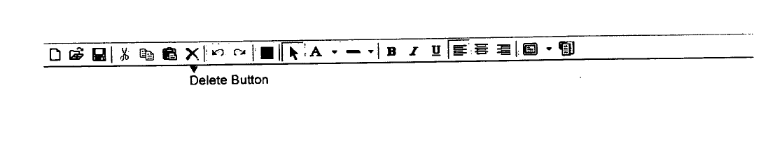

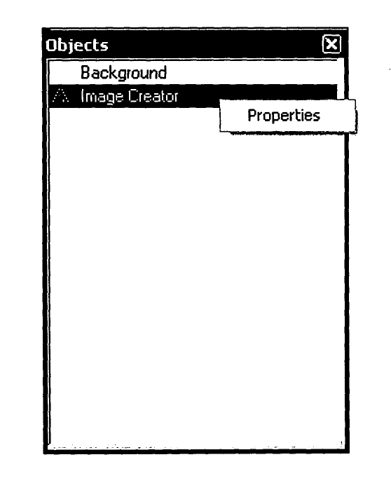

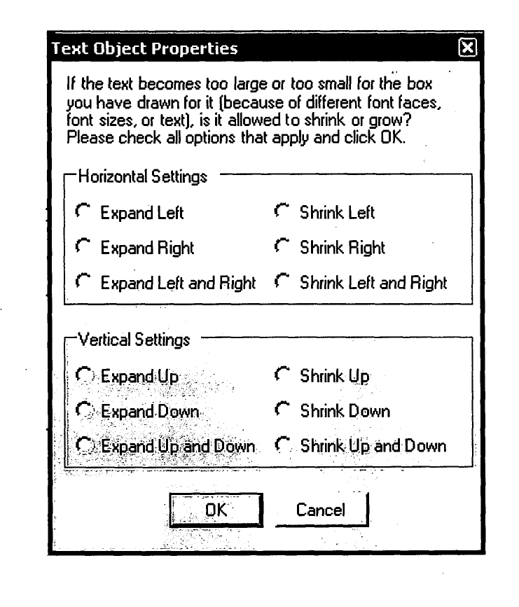

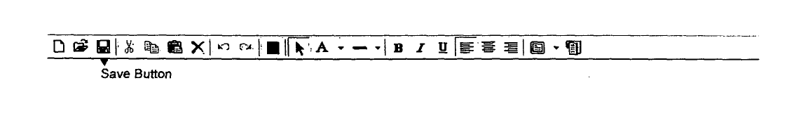

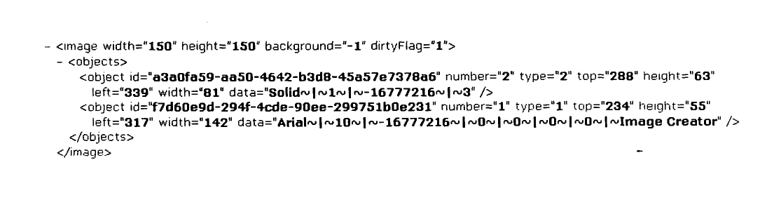

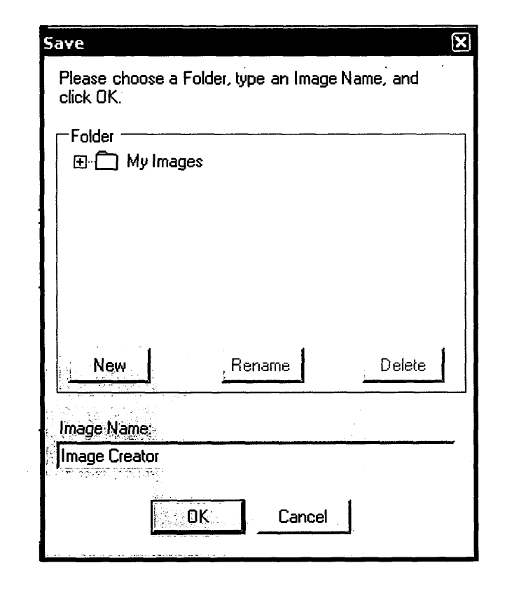

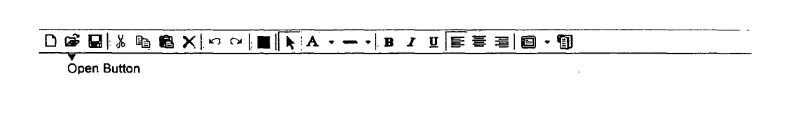

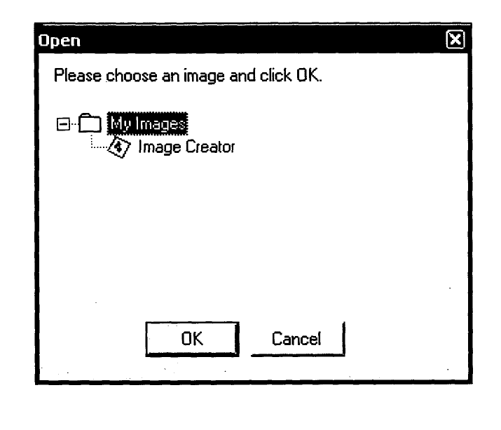

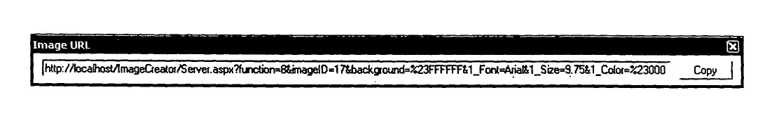

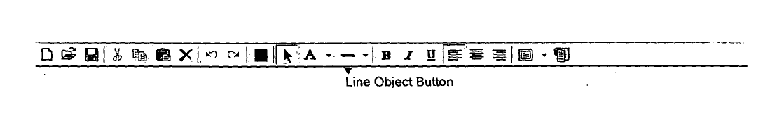

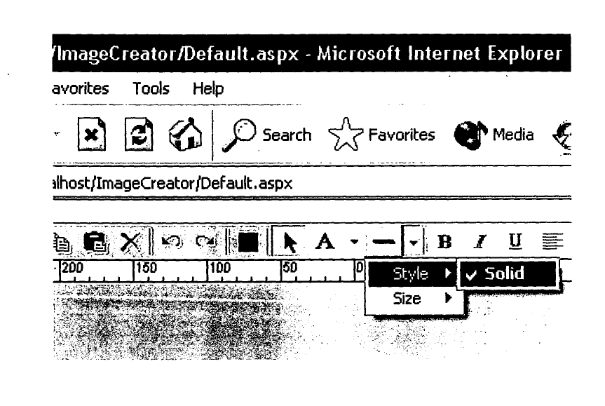

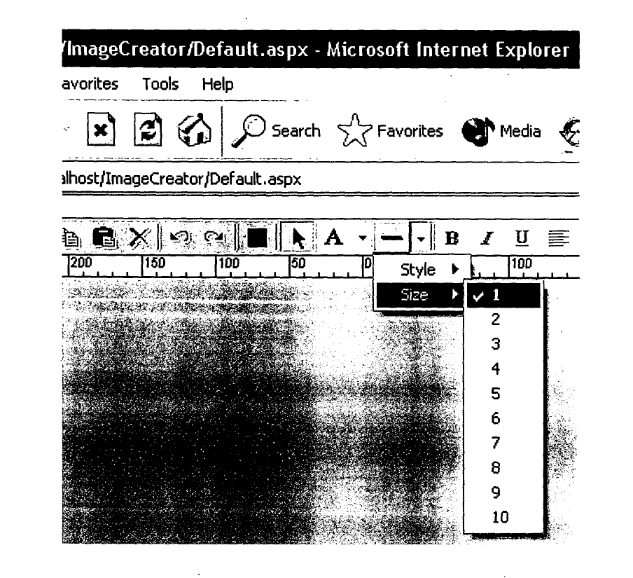

### CROSS-REFERENCE TO RELATED APPLICATIONS

Not applicable.

### STATEMENT REGARDING FEDERALLY SPONSORED RESEARCH OR DEVELOPMENT

Not applicable.

### REFERENCE TO A COMPUTER PROGRAM LISTING COMPACT DISK APPENDIX

The computer program listing has a length of greater than three hundred (300) lines. Therefore, in compliance with 37 CFR § 1.96, it has been submitted separately, in duplicate, on compact disc.

### BACKGROUND OF THE INVENTION

The field of endeavor to which this invention pertains is that of the presentation processing of a document, defined as “manipulating data for generating visually perceptible output.”

The first specific problem inherent to this field of endeavor is that once a document is created, it cannot be presented in different fonts, colors, and/or languages, unless a copy of it is made, the desired changes in fonts, colors, and/or languages applied to the copy, and the copy saved as a separate entity.

The second specific problem inherent to this field of endeavor is that if a person or machine, each time it needed a document to be presented in different fonts, colors, and/or languages, had to first make a copy of the original, apply the desired changes in fonts, colors, and/or languages to the copy, and then save the copy as a separate entity, the value of presenting the document in different fonts, colors, and/or languages is quickly eroded by the amount of time and effort involved in presenting the document in different fonts, colors, and/or languages.

The third specific problem inherent to this field of endeavor is that, because the value of presenting the document in different fonts, colors, and/or languages is quickly eroded by the amount of time and effort involved in presenting the document in different fonts, colors, and/or languages, presenting a document in different fonts, colors, and/or languages is avoided, thereby placing a limitation on applications that use documents.

### BRIEF SUMMARY OF THE INVENTION

The invention is a collection of software that enables its user to create a document once and then display it in any font, color, and/or language.

Additionally, since the document is created using a font face, font size, font style (including, but not limited to, bold, italic, underline), character spacing, and language that, when different for a dynamically rendered document, might cause the contents of the document to either a) exceed the specified width and/or height of the document, or b) fall short of the specified width and/or height of the document, the user can specify which portions of the document, if any, are allowed to expand or shrink horizontally, and/or which portions of the document, if any, are allowed to expand or shrink vertically.

The first specific problem inherent to this field of endeavor is that once a document is created, it cannot be presented in different fonts, colors, and/or languages, unless a copy of it is made, the desired changes in fonts, colors, and/or languages applied to the copy, and the copy saved as a separate entity. The invention solves this specific problem by only requiring that the document be created once, and then displaying it in whatever fonts, colors, and/or languages that its user specifies.

The second specific problem inherent to this field of endeavor is that if a person or machine, each time it needed a document to be presented in different fonts, colors, and/or languages, had to first make a copy of the original, apply the desired changes in fonts, colors, and/or languages to the copy, and then save the copy as a separate entity, the value of presenting the document in different fonts, colors, and/or languages is quickly eroded by the amount of time and effort involved in presenting the document in different fonts, colors, and/or languages. The invention solves this specific problem by automating this process, eliminating the need for manual intervention, and eliminating the need for creating physical entities other than the original document.

The third specific problem inherent to this field of endeavor is that, because the value of presenting the document in different fonts, colors, and/or languages is quickly eroded by the amount of time and effort involved in presenting the document in different fonts, colors, and/or languages, presenting a document in different fonts, colors, and/or languages is avoided, thereby placing a limitation on applications that use documents. The invention solves this specific problem by eliminating the time and effort that was previously needed to present the document in different fonts, colors, and/or languages, and thereby removes limitations placed on applications that use documents.

### BRIEF DESCRIPTION OF THE SEVERAL VIEWS OF THE DRAWING

The patent or application file contains at least one drawing executed in color. Copies of this patent or patent application publication with color drawing(s) will be provided by the Office upon request and payment of the necessary fee.

Drawing 1. Image Creator Login Screen

Drawing 2. Image Creator User Interface

Drawing 3. Image Creator New Button

Drawing 4. Image Creator New Screen

Drawing 5. Image Creator Color Button

Drawing 6. Image Creator New Image

Drawing 7. Image Creator Text Tool Button

Drawing 8. Image Creator Text Object

Drawing 9. Image Creator Text Object Font Name Menu

Drawing 10. Image Creator Text Object Font Size Menu

Drawing 11. Image Creator Text Object Contents

Drawing 12. Image Creator Bold Button

Drawing 13. Image Creator Italic Button

Drawing 14. Image Creator Underline Button

Drawing 15. Image Creator Left Button

Drawing 16. Image Creator Center Button

Drawing 17. Image Creator Right Button

Drawing 18. Image Creator Delete Button

Drawing 19. Image Creator Text Object Properties Context Menu

Drawing 20. Image Creator Text Object Properties Screen

Drawing 21. Image Creator Save Button

Drawing 22. Image Creator/Image Server XML Representation of an Image

Drawing 23. Image Creator Save Screen

Drawing 24. Image Creator Open Button

Drawing 25. Image Creator Open Screen

Drawing 26. Image Creator Image URL Screen

Drawing 27. Image Creator Line Object Button

Drawing 28. Image Creator Line Object Line Style Menu

Drawing 29. Image Creator Line Object Line Size Menu

### DETAILED DESCRIPTION OF THE INVENTION

The invention is a collection of software. The first software component enables its user to create a document (hereinafter referred to as “Image Creator”). The second software component enables a user to specify which fonts, colors, and/or languages to display the document in (hereinafter referred to as “Image Server”).

The Image Creator and Image Server were created using a computer with the following hardware configuration: Intel Pentium 4 Processor running at 2.53 GHz, 256 MB RAM, 64 MB DDR NVIDIA GeForce4 MX 420 graphics card, Samsung SW-248F CD-R/RW drive, WDC WD300BB-75DEA0 hard drive (partitioned as 10 GB C-drive; 750 MB D-drive), Samsung SD616T DVD-ROM drive, standard 101/102-key keyboard, PS/2 compatible mouse, BCM v.92 56K modem, 17″ flat-panel LCD monitor, Intel PRO/100 VE network card, Creative Labs SB Live! sound card. The network card was connected to an active intranet with Internet connectivity.

The Image Creator and Image Server were created using a computer with the above hardware configuration and the following software configuration: Microsoft Windows XP Professional operating system with Service Pack 1, Internet Information Services, Microsoft Visual Studio .NET 2003 installed with Microsoft Visual Basic .NET, Microsoft Internet Explorer version 6.0, Microsoft SQL Server 2000 Enterprise Edition.

Steps to create the Image Creator:
a. Start Windows XP. Click the “Start” button. Click “My Computer.” In the window that appears, double-click the “D” drive. Create a new folder called “Nervology” and double-click it.

Create a new folder called “Technology” and double-click it. Create a new folder called “Source” and double-click it. Create a new folder called “Products” and double-click it. Create a new folder called “TBD” and double-click it. Create a new folder called “1.0.0” and double-click it. Create a new folder called “Components.” Create a new folder called “Database.” Create a new folder called “Solution.” Create a new folder called “Web Project.” Double-click the “Components” folder. Create a new folder called “Business Layer.” Create a new folder called “Data Layer.” Create a new folder called “Presentation Layer.”
b. Click the “Start” button. Click “Control Panel.” In the window that appears, double-click “Administrative Tools.” Double-click “Internet Information Services.” In the new window that appears, expand the tree-view until “Default Web Site” appears. Right-click on “Default Web Site.” In the menu that appears, click “Properties.” In the window that appears, click the “Home Directory” tab. Click the “Browse. . . ” button next to “Local Path.” In the window that appears, double-click the “D” drive. Double-click the “Nervology” folder. Double-click the “Technology” folder. Double-click the “Source” folder. Double-click the “Products” folder. Double-click the “TBD” folder. Double-click the “1.0.0” folder. Double-click the “Web Project” folder. Click the “OK” button. That window will close. In the window that appears, click the “OK” button.
c. Start Microsoft Visual Studio .NET 2003.
d. Click the “File” menu. In the menu that appears, click “New.” In the menu that appears, click “Project . . . ”
e. A new window will appear. In the tree-view under “Project Types” click the “Visual Basic Projects” folder. In the list-view under “Templates” click the “ASP.NET Web Application” icon. Type “Web” into the text-box next to “Name.” Click the “Browse . . . ” button next to “Location.” In the new window that appears, click the “Desktop” icon. Double-click “My Computer.” Double-click the “D” drive. Double-click the “Nervology” folder. Double-click the “Technology” folder. Double-click the “Source” folder. Double-click the “Products” folder. Double-click the “TBD” folder. Double-click the “1.0.0” folder. Double-click the “Web Project” folder. Click the “Open” button. That window will close. In the window that appears, click the “OK” button.
f. Once the “Web” project appears in the “Solution Explorer” window, close Microsoft Visual Studio .NET 2003.
g. Click the “Start” button. Click “Control Panel.” In the window that appears, double-click “Administrative Tools.” Double-click “Internet Information Services.” In the new window that appears, expand the tree-view until “Default Web Site” appears. Right-click on “Default Web Site.” In the menu that appears, click “Properties.” In the window that appears, click the “Home Directory” tab. Click the “Browse . . . ” button next to “Local Path.” In the window that appears, double-click the “D” drive. Click the “OK” button. That window will close. In the window that appears, click the “OK” button.
h. Click the “Start” button. Click “My Computer.” Double-click the “D” drive. Double-click the “Nervology” folder. Double-click the “Technology” folder. Double-click the “Source” folder. Double-click the “Products” folder. Double-click the “TBD” folder. Double-click the “1.0.0” folder. Double-click the “Web Project” folder. Double-click the “Web” folder. Select all files and folders. Click the “Edit” menu. In the menu that appears, click “Cut.” Click the “Back” button. Click the “Edit” menu. In the menu that appears, click “Paste.” Click the “Web” folder. Press the “Delete” key. In the window that appears, click the “Yes” button.
i. Click the “Start” button. Click “Control Panel.” In the window that appears, double-click “Administrative Tools.” Double-click “Internet Information Services.” In the new window that appears, expand the tree-view until “Default Web Site” appears. Right-click on “Default Web Site.” In the menu that appears, click “Properties.” In the window that appears, click the “Home Directory” tab. Click the “Browse . . . ” button next to “Local Path.” In the window that appears, double-click the “D” drive. Double-click the “Nervology” folder. Double-click the “Technology” folder. Double-click the “Source” folder. Double-click the “Products” folder. Double-click the “TBD” folder. Double-click the “1.0.0” folder. Double-click the “Web Project” folder. Click the “OK” button. That window will close. In the window that appears, click the “OK” button.
j. Start Microsoft Visual Studio .NET 2003.
k. Click the “File” menu. In the menu that appears, click “New.” In the menu that appears, click “Blank Solution . . . ” Type “Solution” into the text-box next to “Name.” Click the “Browse . . . ” button next to “Location.” In the new window that appears, click the “Desktop” icon. Double-click “My Computer.” Double-click the “D” drive. Double-click the “Nervology” folder. Double-click the “Technology” folder. Double-click the “Source” folder. Double-click the “Products” folder. Double-click the “TBD” folder. Double-click the “1.0.0” folder. Double-click the “Solution” folder. Click the “OK” button. That window will close.
l. In the “Solution Explorer” window, right-click the “Solution” item. In the menu that appears, click “Add.” In the menu that appears, click “Existing Project . . . ” In the new window that appears, click the “Desktop” icon. Double-cick “My Computer.” Double-click the “D” drive. Double-click the “Nervology” folder. Double-click the “Technology” folder. Double-click the “Source” folder. Double-click the “Products” folder. Double-click the “TBD” folder. Double-click the “1.0.0” folder. Double-click the “Web Project” folder. Click the “Web.vbproj” file. Click the “Open” button. That window will close.
m. In the “Solution Explorer” window, right-click the “Solution” item. In the menu that appears, click “Add.” In the menu that appears, click “New Project . . . ” A new window will appear. In the tree-view under “Project Types” click the “Visual Basic Projects” folder. In the list-view under “Templates” click the “Class Library” icon. Type “Nervology_DL_Core” into the text-box next to “Name.” Click the “Browse . . . ” button next to “Location.” In the new window that appears, click the “Desktop” icon. Double-click “My Computer.” Double-click the “D” drive. Double-click the “Nervology” folder. Double-click the “Technology” folder. Double-click the “Source” folder. Double-click the “Products” folder. Double-click the “TBD” folder. Double-click the “1.0.0” folder. Double-click the “Components” folder. Double-click the “Data Layer” folder. Click the “Open” button. That window will close. In the window that appears, click the “OK” button.
n. In the “Solution Explorer” window, click the “Class1” file under the “Nervology_DL_Core” project. Press the “Delete” key. In the window that appears, click the “OK” button.
o. In the “Solution Explorer” window, right-click the “Nervology_DL_Core” project. In the menu that appears, click “Add.” In the menu that appears, click “Add Class . . . ” A new window will appear. Type “clsSqlDataAccess” into the text-box next to “Name.” Click the “Open” button. Copy the code from the computer program listing for “Components/Data Layer/Nervology_DL_Core/cisSqlDataAccess.vb into the code window. Click the “File” menu. In the menu that appears, click “Save.” Click the “File” menu. In the menu that appears, click “Close.”
p. In the “Solution Explorer” window, right-click the “Nervology_DL_Core” project. In the menu that appears, click “Add.” In the menu that appears, click “Add Class . . . ” A new window will appear. Type “clsOleDataAccess” into the text-box next to “Name.” Click the “Open” button. Copy the code from the computer program listing for “Components/Data Layer/Nervology_DL_Core/clsOleDataAccess.vb into the code window. Click the “File” menu. In the menu that appears, click “Save.” Click the “File” menu. In the menu that appears, click “Close.”
q. In the “Solution Explorer” window, right-click the “Nervology_DL_Core” project. In the menu that appears, click “Add.” In the menu that appears, click “Add Module . . . ” A new window will appear. Type “modMain” into the text-box next to “Name.” Click the “Open” button. Copy the code from the computer program listing for “Components/Data Layer/Nervology_DL_Core/modMain.vb into the code window. Click the “File” menu. In the menu that appears, click “Save.” Click the “File” menu. In the menu that appears, click “Close.”
r. In the “Solution Explorer” window, right-click the “Solution” item. In the menu that appears, click “Add.” In the menu that appears, click “New Project . . . ” A new window will appear. In the tree-view under “Project Types” click the “Visual Basic Projects” folder. In the list-view under “Templates” click the “Class Library” icon. Type “Nervology_BL_Core” into the text-box next to “Name.” Click the “Browse . . . ” button next to “Location.” In the new window that appears, click the “Desktop” icon. Double-click “My Computer.” Double-click the “D” drive. Double-click the “Nervology” folder. Double-click the “Technology” folder. Double-click the “Source” folder. Double-click the “Products” folder. Double-click the “TBD” folder. Double-click the “1.0.0” folder. Double-click the “Components” folder. Double-click the “Business Layer” folder. Click the “Open” button. That window will close. In the window that appears, click the “OK” button.
s. In the “Solution Explorer” window, click the “Classl” file under the “Nervology_BL_Core” project. Press the “Delete” key. In the window that appears, click the “OK” button.
t. In the “Solution Explorer” window, right-click the “Nervology_BL_Core” project. In the menu that appears, click “Add.” In the menu that appears, click “Add Class . . . ” A new window will appear. Type “clsField” into the text-box next to “Name.” Click the “Open” button. Copy the code from the computer program listing for “Components/Business Layer/Nervology_BL_Core/cIsField.vb into the code window. Click the “File” menu. In the menu that appears, click “Save.” Click the “File” menu. In the menu that appears, click “Close.”
u. In the “Solution Explorer” window, right-click the “Nervology_BL_Core” project. In the menu that appears, click “Add.” In the menu that appears, click “Add Class . . . ” A new window will appear. Type “clsValidation” into the text-box next to “Name.” Click the “Open” button. Copy the code from the computer program listing for “Components/Business Layer/Nervology_BL_Core/clsValidation.vb into the code window. Click the “File” menu. In the menu that appears, click “Save.” Click the “File” menu. In the menu that appears, click “Close.”
v. In tne “Solution Explorer” window, right-click the “Nervology_BL_Core” project. In the menu that appears, click “Add.” In the menu that appears, click “Add Module . . . ” A new window will appear. Type “modMain” into the text-box next to “Name.” Click the “Open” button. Copy the code from the computer program listing for “Components/Business Layer/Nervology_BL_Core/modMain.vb into the code window. Click the “File” menu. In the menu that appears, click “Save.” Click the “File” menu. In the menu that appears, click “Close.”
w. In the “Solution Explorer” window, right-click the “Nervology_BL_Core” project. In the menu that appears, click “Add.” In the menu that appears, click “Add New Item . . . ” A new window will appear. In the list-view under “Templates” click the “Assembly Resource File” icon. Type “Strings.Resources.resx” into the text-box next to “Name.” Click the “Open” button. Right-click the designer surface. In the menu that appears, click “XML Source.” Copy the code from the computer program listing for “Components/Business Layer/Nervology_BL_Core/Strings.Resources.Resx into the code window. Click,the “File” menu. In the menu that appears, click “Save.” Click the “File” menu. ln the menu that-appears, click “Close.”
x. In the “Solution Explorer” window, right-click the “Solution” item. In the menu that appears, click “Add.” In the menu that appears, click “New Project . . . ” A new window will appear. In the tree-view under “Project Types” click the “Visual Basic Projects” folder. In the list-view under “Templates” click the “Class Library” icon. Type “PL_Core” into the text-box next to “Name.” Click the “Browse . . . ” button next to “Location.” In the new window that appears, click the “Desktop” icon. Double-click “My Computer.” Double-click the “D” drive. Double-click the “Nervology” folder. Double-click the “Technology” folder. Double-click the “Source” folder. Double-click the “Products” folder. Double-click the “TBD” folder. Double-click the “1.0.0” folder. Double-click the “Components” folder. Double-click the “Presentation Layer” folder. Click the “Open” button. That window will close. In the window that appears, click the “OK” button.
y. In the “Solution Explorer” window, click the “Class1” file under the “PL_Core” project. Press the “Delete” key. In the window that appears, click the “OK” button.
z. In the “Solution Explorer” window, right-click the “PL_Core” project. In the menu that appears, click “Add.” In the menu that appears, click “Add Class . . . ” A new window will appear. Type “clsImageEditor” into the text-box next to “Name.” Click the “Open” button. Copy the code from the computer program listing for “Components/Presentation Layer/PL_Core/cisImageEditor.vb into the code window. Click the “File” menu. In the menu that appears, click “Save.” Click the “File” menu. In the menu that appears, click “Close.”
aa. In the “Solution Explorer” window, right-click the “PL_Core” project. In the menu that appears, click “Add.” In the menu that appears, click “Add Class . . . ” A new window will appear. Type “clsUserSession” into the text-box next to “Name.” Click the “Open” button. Copy the code from the computer program listing for “Components/Presentation Layer/PL_Core/clsUserSession.vb into the code window. Click the “File” menu. In the menu that appears, click “Save.” Click the “File” menu. In the menu that appears, click “Close.”
ab. In the “Solution Explorer” window, right-click the “PL_Core” project. In the menu that appears, click “Add.” In the menu that appears, click “Add Module . . . ” A new window will appear. Type “modMain” into the text-box next to “Name.” Click the “Open” button. Copy the code from the computer program listing for “Components/Presentation Layer/PL_Core/modMain.vb into the code window. Click the “File” menu. In the menu that appears, click “Save.” Click the “File” menu. In the menu that appears, click “Close.”
ac. In the “Solution Explorer” window, right-click the “PL_Core” project. In the menu that appears, click “Add.” In the menu that appears, click “Add Class . . . ” A new window will appear. Type “WebObjects” into the text-box next to “Name.” Click the “Open” button. Copy the code from the computer program listing for “Components/Presentation Layer/PL_Core/WebObjects.vb into the code window. Click the “File” menu. In the menu that appears, click “Save.” Click the “File” menu. In the menu that appears, click “Close.”
ad. In the “Solution Explorer” window, right-click the “Solution” item. In the menu that appears, click “Add.” In the menu that appears, click “New Project . . . ” A new window will appear. In the tree-view under “Project Types” click the “Visual Basic Projects” folder. In the list-view under “Templates” click the “Windows Control Library” icon. Type “PL_ImageEditor” into the text-box next to “Name.” Click the “Browse . . . ” button next to “Location.” In the new window that appears, click the “Desktop” icon. Double-click “My Computer.” Double-click the “D” drive. Double-click the “Nervology” folder. Double-click the “Technology” folder. Double-click the “Source” folder. Double-click the “Products” folder. Double-click the “TBD” folder. Double-click the “1.0.0” folder. Double-click the “Components” folder. Double-click the “Presentation Layer” folder. Click the “Open” button. That window will close. In the window that appears, click the “OK” button.
ae. In the “Solution Explorer” window, click the “UserControl1” file under the “PL_ImageEditor” project. Press the “Delete” key. In the window that appears, click the “OK” button.
af. In the “Solution Explorer” window, right-click the “PL_ImageEditor” project. In the menu that appears, click “Add.” In the menu that appears, click “Add Class . . . ” A new window will appear. Type “clsImageServer” into the text-box next to “Name.” Click the “Open” button. Copy the code from the computer program listing for “Components/Presentation Layer/PL_ImageEditor/cisImageServer.vb into the code window. Click the “File” menu. In the menu that appears, click “Save.” Click the “File” menu. In the menu that appears, click “Close.”
ag. In the “Solution Explorer” window, right-click the “PL_ImageEditor” project. In the menu that appears, click “Add.” In the menu that appears, click “Add Class . . . ” A new window will appear. Type “cisToolCoordinates” into the text-box next to “Name.” Click the “Open” button. Copy the code from the computer program listing for “Components/Presentation Layer/PL_ImageEditor/clsToolCoordinates.vb into the code window. Click the “File” menu. In the menu that appears, click “Save.” Click the “File” menu. In the menu that appears, click “Close.”
ah. In the “Solution Explorer” window, right-click the “PL_ImageEditor” project. In the menu that appears, click “Add.” In the menu that appears, click “Add User Control . . . ” A new window will appear. Type “ctlLineObject” into the text-box next to “Name.” Click the “Open” button. Copy the code from the computer program listing for “Components/Presentation Layer/PL_ImageEditor/ctlLineObject.vb into the code window. Click the “File” menu. In the menu that appears, click “Save.” Click the “File” menu. In the menu that appears, click “Close.”
ai. In the “Solution Explorer” window, right-click the “PL_ImageEditor” project. In the menu that appears, click “Add.” In the menu that appears, click “Add User Control . . . ” A new window will appear. Type “ctlRichTextBox” into the text-box next to “Name.” Click the “Open” button. Copy the code from the computer program listing for “Components/Presentation Layer/PL_ImageEditor/ctlRichTextBox.vb into the code window. Click the “File” menu. In the menu that appears, click “Save.” Click the “File” menu. In the menu that appears, click “Close.”
aj. In the “Solution Explorer” window, right-click the “PL_ImageEditor” project. In the menu that appears, click “Add.” In the menu that appears, click “Add User Control . . . ” A new window will appear. Type “ctlRuler” into the text-box next to “Name.” Click the “Open” button. Copy the code from the computer program listing for “Components/Presentation Layer/PL_ImageEditor/ctlRuler.vb into the code window. Click the “File” menu. In the menu that appears, click “Save.” Click the “File” menu. In the menu that appears, click “Close.”
ak. In the “Solution Explorer” window, right-click the “PL_ImageEditor” project. In the menu that appears, click “Add.” In the menu that appears, click “Add User Control . . . ” A new window will appear. Type “ctlTextObject” into the text-box next to “Name.” Click the “Open” button. Copy the code from the computer program listing for “Components/Presentation Layer/PL_ImageEditor/ctlTextObject.vb into the code window. Click the “File” menu. In the menu that appears, click “Save.” Click the “File” menu. In the menu that appears, click “Close.”
al. In the “Solution Explorer” window, right-click the “PL_ImageEdito” project. In the menu that appears, click “Add.” In the menu that appears, click “Add Windows Form . . . ” A new window will appear. Type “frmConfigure” into the text-box next to “Name.” Click the “Open” button. Copy the code from the computer program listing for “Components/Presentation Layer/PL_ImageEditor/frmConfigure.vb into the code window. Click the “File” menu. In the menu that appears, click “Save.” Click the “File” menu. In the menu that appears, click “Close.”
am. In the “Solution Explorer” window, right-click the “PL_ImageEditor” project. In the menu that appears, click “Add.” In the menu that appears, click “Add Windows Form . . . ” A new window will appear. Type “frmImageURL” into the text-box next to “Name.” Click the “Open” button. Copy the code from the computer program listing for “Components/Presentation Layer/PL_ImageEditor/frmImageURL.vb into the code window. Click the “File” menu. In the menu that appears, click “Save.” Click the “File” menu. In the menu that appears, click “Close.”
an. In the “Solution Explorer” window, right-click the “PL_ImageEditor” project. In the menu that appears, click “Add.” In the menu that appears, click “Add Windows Form . . . ” A new window will appear. Type “frmLogin” into the text-box next to “Name.” Click the “Open” button. Copy the code from the computer program listing for “Components/Presentation Layer/PL_ImageEditor/frmLogin.vb into the code window. Click the “File” menu. In the menu that appears, click “Save.” Click the “File” menu. In the menu that appears, click “Close.”
ao. In the “Solution Explorer” window, right-click the “PL_ImageEditor” project. In the menu that appears, click “Add.” In the menu that appears, click “Add Windows Form . . . ” A new window will appear. Type “frmNew” into the text-box next to “Name.” Click the “Open” button. Copy the code from the computer program listing for “Components/Presentation Layer/PL_ImageEditor/frmNew.vb into the code window. Click the “File” menu. In the menu that appears, click “Save.” Click the “File” menu. In the menu that appears, click “Close.”
ap. In the “Solution Explorer” window, right-click the “PL_ImageEditor” project. In the menu that appears, click “Add.” In the menu that appears, click “Add Windows Form . . . ” A new window will appear. Type “frmObjects” into the text-box next to “Name.” Click the “Open” button. Copy the code from the computer program listing for “Components/Presentation Layer/PL_ImageEditor/frmObjects.vb into the code window. Click the “File” menu. In the menu that appears, click “Save.” Click the “File” menu. In the menu that appears, click “Close.”
aq. In the “Solution Explorer” window, right-click the “PL_ImageEditor” project. In the menu that appears, click “Add.” In the menu that appears, click “Add Windows Form . . . ” A new window will appear. Type “frmOpen” into the text-box next to “Name.” Click the “Open” button. Copy the code from the computer program listing for “Components/Presentation Layer/PL_ImageEditor/frmOpen.vb into the code window. Click the “File” menu. In the menu that appears, click “Save.” Click the “File” menu. In the menu that appears, click “Close.”
ar. In the “Solution Explorer” window, right-click the “PL_ImageEditor” project. In the menu that appears, click “Add.” In the menu that appears, click “Add Windows Form . . . ” A new window will appear. Type “frmSave” into the text-box next to “Name.” Click the “Open” button. Copy the code from the computer program listing for “Components/Presentation Layer/PL_ImageEditor/frmSave.vb into the code window. Click the “File” menu. In the menu that appears, click “Save.” Click the “File” menu. In the menu that appears, click “Close.”
as. In the “Solution Explorer” window, right-lick the “PL_ImageEditor” project. In the menu that appears, click “Add.” In the menu that appears, click “Add Windows Form . . . ” A new window will appear. Type “frmTextObjectProperties” into the text-box next to “Name.” Click the “Open” button. Copy the code from the computer program listing for “Components/Presentation Layer/PL_ImageEditor/frmTextObjectProperties.vb into the code window. Click the “File” menu. In the menu that appears, click “Save.” Click the “File” menu. In the menu that appears, click “Close.”
at. In the “Solution Explorer” window, right-lick the “PL_ImageEditor” project. In the menu that appears, click “Add.” In the menu that appears, click “Add User Control . . . ” A new window will appear. Type “ImageCreator” into the text-box next to “Name.” Click the “Open” button. Copy the code from the computer program listing for “Components/Presentation Layer/PL_ImageEditor/ImageCreator.vb into the code window. Click the “File” menu. In the menu that appears, click “Save.” Click the “File” menu. In the menu that appears, click “Close.”
au. In the “Solution Explorer” window, right-click the “PL_ImageEditor” project. In the menu that appears, click “Add.” In the menu that appears, click “Add Module . . . ” A new window will appear. Type “modMain” into the text-box next to “Name.” Click the “Open” button. Copy the code from the computer program listing for “Components/Presentation Layer/PL_ImageEditor/modMain.vb into the code window. Click the “File” menu. In the menu that appears, click “Save.” Click the “File” menu. In the menu that appears, click “Close.”
av. In the “Solution Explorer” window, right-click the “Web” project. In the menu that appears, click “Add.” In the menu that appears, click “Add Folder . . . ” Rename the new folder “ImageCreator.”
aw. In the “Solution Explorer” window, right-click the “ImageCreator” folder in the “Web” project. In the menu that appears, click “Add.” In the menu that appears, click “Add Web Form . . . ” A new window will appear. Type “Default.aspx” into the text-box next to “Name.” Click the “Open” button.
ax. Right-click on the designer surface. In the menu that appears, click “View Code.” Copy the code from the computer program listing for “Web Project/ImageCreator/Default.aspx” into the code window. Click the “File” menu. In the menu that appears, click “Save.” Click the “File” menu. In the menu that appears, click “Close.”
ay. In the “Solution Explorer” window, right-lick the “Web” project. In the menu that appears, click “Add Reference . . . ” A new window will appear. Click the “Projects” tab. Double-click the “PL_Core” project. Double-click the “PL_ImageCreator” project. Click “OK.” That window will close.

Steps to create the Image Server:
a. In the “Solution Explorer” window, right-click the “Solution” item. In the menu that appears, click “Add.” In the menu that appears, click “New Project . . . ” A new window will appear. In the tree-view under “Project Types” click the “Visual Basic Projects” folder. In the list-view under “Templates” click the “Class Library” icon. Type “BL_Server” into the text-box next to “Name.” Click the “Browse . . . ” button next to “Location.” In the new window that appears, click the “Desktop” icon. Double-click “My Computer.” Double-click the “D” drive. Double-click the “Nervology” folder. Double-click the “Technology” folder. Double-click the “Source” folder. Double-click the “Products” folder. Double-click the “TBD” folder. Double-click the “1.0.0” folder. Double-click the “Components” folder. Double-click the “Business Layer” folder. Click the “Open” button. That window will close. In the window that appears, click the “OK” button.
b. In the “Solution Explorer” window, right-click the “BL_Server” project. In the menu that appears, click “Add Reference . . . ” A new window will appear. Click the “Projects” tab. Double-click the “Nervology_DL_Core” project. Double-click the “Nervology_BL_Core” project. Click “OK.” That window will close.
c. In the “Solution Explorer” window, right-click the “BL_Server” project. In the menu that appears, click “Add.” In the menu that appears, click “Add Class . . . ” A new window will appear. Type “cIsServer” into the text-box next to “Name.” Click the “Open” button. Copy the code from the computer program listing for “Components/Business Layer/BL_Server/clsServer.vb into the code window. Click the “File” menu. In the menu that appears, click “Save.” Click the “File” menu. In the menu that appears, click “Close.”
d. In the “Solution Explorer” window, right-click the “BL_Server” project. In the menu that appears, click “Add.” In the menu that appears, click “Add Module . . . ” A new window will appear. Type “modMain” into the text-box next to “Name.” Click the “Open” button. Copy the code from the computer program listing for “Components/Business Layer/BL_Server/modMain.vb into the code window. Modify the return value of the “GetDBConnection” function to return the proper database connection string for the database that will be used. Click the “File” menu. In the menu that appears, click “Save.” Click the “File” menu. In the menu that appears, click “Close.”
e. In the “Solution Explorer window, right-click the “Solution” item. In the menu that appears, click “Add.” In the menu that appears, click “New Project . . . ” A new window will appear. In the tree-view under “Project Types” click the “Visual Basic Projects” folder. In the list-view under “Templates” click the “Class Library” icon. Type “PL_Server” into the text-box next to “Name.” Click the “Browse . . . ” button next to “Location.” In the new window that appears, click the “Desktop” icon. Double-click “My Computer.” Double-click the “D” drive. Double-click the “Nervology” folder. Double-click the “Technology” folder. Double-click the “Source” folder. Double-click the “Products” folder. Double-click the “TBD” folder. Double-click the “1.0.0” folder. Double-click the “Components” folder. Double-click the “Presentation Layer” folder. Click the “Open” button. That window will close. In the window that appears, click the “OK” button.
f. In the “Solution Explorer” window, right-click the “PL_Server” project. In the menu that appears, click “Add Reference . . . ” A new window will appear. Click the “Projects” tab. Double-click the “BL_Server” project. Click OK.” That window will close.
g. In the “Solution Explorer” window, right-click the “PL_Server” project. In the menu that appears, click “Add.” In the menu that appears, click “Add Class . . . ” A new window will appear. Type “Server” into the text-box next to “Name.” Click the “Open” button. Copy the code from the computer program listing for “Components/Presentation Layer/BL_Server/Server.vb into the code window. Click the “File” menu. In the menu that appears, click “Save.” Click the “File” menu. In the menu that appears, click “Close.”
h. In the “Solution Explorer” window, right-click the “ImageCreator” folder in the “Web” project. In the menu that appears, click “Add.” In the menu that appears, click “Add Web Form . . . ” A new window will appear. Type “Server.aspx” into the text-box next to “Name.” Click the “Open” button.
i. Right-click on the designer surface. In the menu that appears, click “View Code.” Copy the code from the computer program listing for “Web Project/ImageCreator/Server.aspx” into the code window. Click the “File” menu. In the menu that appears, click “Save.” Click the “File” menu. In the menu that appears, click “Close.”
j. In the “Solution Explorer” window, right-click the “Web” project. In the menu that appears, click “Add Reference . . . ” A new window will appear. Click the “Projects” tab. Double-click the “PL_Server” project. Click “OK.” That window will close.

Steps to compile the Image Creator and the Image Server:
a. In the “Solution Explorer” window, right-click the “Web” project. In the menu that appears, click “Set as StartUp Project.”
b. In the “Solution Explorer” window, right-click the “Default.aspx” page in the “ImageCreator” folder in the “Web” project. In the menu that appears, click “Set as StartUp Page.”
c. In the “Solution Explorer” window, right-click the “Web” project. In the menu that appears, click “Build.”
d. Click the “Start” button. Click “My Computer.” A new window will appear. Double-click the “D” drive. Double-click the “Nervology” folder. “Double-click the “Technology” folder. Double-click the “Source” folder. Double-click the “Products” folder. Double-click the “TBD” folder. Double-lick the “1.0.0” folder. Double-click the “Components” folder. Double-click the “Presentation Layer” folder. Double-click the “PL_ImageCreator” folder. Double-click the “bin” folder. Select the “PL_ImageCreator.dll” and “PL_ImageCreator.pdb” files. Click the “Edit” menu. In the menu that appears, click “Copy.”
e. Click the “Start” button. Click “My Computer.” A new window will appear. Double-click the “D” drive. Double-click the “Nervology” folder. “Double-click the “Technology” folder. Double-click the “Source” folder. Double-click the “Products” folder. Double-click the “TBD” folder. Double-click the “1.0.0” folder. Double-click the “Web Project” folder. Double-click the “ImageCreator” folder. Click the “Edit” menu. In the menu that appears, click “Paste.” In the window that appears, click “Yes.” In the window that appears, click “Yes.”
f. Start Microsoft SQL Server 2000 Enterprise Edition Enterprise Manager.
g. In the new window that appears, expand the tree-view to the show the SQL server that the database will be hosted on (this should match the value returned by the “GetDBConnection” function in BL_Server/modMain.vb).
h. Double-click the SQL server.
i. Right-click the “Databases” folder. In the menu that appears, click “New Database . . . ” A new window will appear. Type “nervo2” into the text-box next to “Name” (or type the name of the database used in the “GetDBConnection” function in BL_Server/modMain.vb). Click the “OK” button.
j. Double-click the new database in the tree-view.
k. Click the “Tools” menu. In the menu that appears, click “SQL Query Analyzer.” A new window will appear. Ensure that the new database is selected in the database drop-down.
l. Copy the code from the computer program listing for “Database/Tables/Create Tables.sql” into the command window. Click the “Query” menu. Click “Execute.” Select all the code. Press the “Delete” key.
m. Copy the code from the computer program listing for “Database/Stored Procedures/Create Stored Procedures.sql” into the command window. Click the “Query” menu. Click “Execute.” Select all the code. Press the “Delete” key.
n. Copy the code from the computer program listing for “Database/Scripts/Create Seed Data.sql” into the command window. Click the “Query” menu. Click “Execute.” Select all the code. Press the “Delete” key.

Using the Image Creator. A user of the Image Creator will use it in one of, but not limited to, the following ways: a) via an application that is installed on their computer, b) via Microsoft Internet Explorer on a web page hosted by Nervology. For the sake of demonstrating how the Image Creator is used, the latter approach will be used.

Prior to using the Image Creator, a user will have been provided a User ID (hereinafter “User ID”) and Password (hereinafter “Password”) with which to access the Image Creator.
a. Start Microsoft Internet Explorer.
b. Type “http://www.nervology.com/ImageCreator/Default.aspx” into the text-box next to “Address.” Press the “Enter” or “Return” key. What is typed into this text-box may change depending on installation specifics (i.e., if the software is hosted by Nervology or a third party, or if the location of the software is in its default location or an alternate location).
c. A window named “Login” will appear (Drawing 1). The user types the Image Server URL into the text-box next to “Image Server URL.” The Image Server URL is determined by installation specifics (i.e., if the software is hosted by Nervology or a third party, or if the location of the software is in its default location or an alternate location). The user types their User ID into the text-box next to “User ID.” The user types their Password into the text-box next to “Password.” If the user clicks the “OK” button and the Image Server URL and User ID and Password are valid, the window closes. If the user clicks the “OK” button and the Image Server URL or User ID or Password are not valid, a message indicating such appears and the user must make the necessary corrections. If the user clicks the “Cancel” button the window closes and use of the Image Creator is not allowed. For the sake of this demonstration, we will assume the user has typed a valid Image Server URL and User ID and Password and has clicked the “OK” button.
d. The Image Creator will appear (Drawing 2).
e. A new image is created by clicking the “New” toolbar icon (Drawing 3).
f. A window named “New” will appear (Drawing 4). The user types their desired value for the image's width in pixels into the text-box next to “Width in Pixels.” The value must be a whole number between 1 and 736. The user types their desired value for the image's height in pixels into the text- box next to “Height in Pixels.” The value must be a whole number between 1 and 520. The user chooses what they would like the background color of the new image to be. The background color can be white, transparent, or the color currently selected in the “Color” toolbar icon (Drawing 5). If the user clicks the “OK” button and the Width in Pixels and Height in Pixels are valid, the window closes. If the user clicks the “OK” button and the Width in Pixels or the Height in Pixels are not valid, a message indicating such appears and the user must make the necessary corrections. If the user clicks the “Cancel” button, the window closes and the new image is not created. For the sake of this demonstration, we will assume the user has typed a valid Width in Pixels and Height in Pixels and has clicked the “OK” button.
g. The new image is created according to the specified Width in Pixels, Height in Pixels and Background Color (Drawing 6). In this demonstration, the user typed a value of “150” for the Width in Pixels, typed a value of “150” for the Height in Pixels, and chose “White” as the Background Color.
h. Text objects are added to the image. A text object is created by clicking the “Text Tool” toolbar icon (Drawing 7). The user then pushes the left mouse button down where the top-left corner of the text object should start, drags to the location where the bottom-right corner of the text object should stop, then releases the left mouse button, and the text object is created (Drawing 8). The text object is created with the currently selected font name (Drawing 9) and font size (Drawing 10).
i. Editing a text object. A text object is editable when it is selected. When a text object is first created, it is automatically selected; The user can immediately type the appropriate text (Drawing 11). The font name of the text object can be changed by selecting all the text or not selecting any text and choosing the desired font name from the font name menu (Drawing 9). The font size of the text object can be changed by selecting all the text or not selecting any text and choosing the desired font size from the font size menu (Drawing 10). The font style can be changed to bold by selecting all the text or not selecting any text and clicking the “Bold” toolbar icon (Drawing 12). The font style can be changed to italic by selecting all the text or not selecting any text and clicking the “Italic” toolbar icon (Drawing 13). The font style can be changed to underline by selecting all the text or not selecting any text and clicking the “Underline” toolbar icon (Drawing 14). Any combination of bold, italic and underline can be selected. The font alignment can be changed to left by selecting all the text or not selecting any text and clicking the “Left” toolbar icon (Drawing 15). The font alignment can be changed to center by selecting all the text or not selecting any text and clicking the “Center” toolbar icon (Drawing 16). The font alignment can be changed to right by selecting all the text or not selecting any text and clicking the “Right” toolbar icon (Drawing 17). No combination of left, center and right can be selected. The font color can be changed to any available color by selecting all the text or not selecting any text and clicking the “Color” toolbar icon (Drawing 5).
j. Resizing a text object. A text object is resizable when it is selected. When a text object is first created, it is automatically selected. The user can immediately resize the text object. The text object can be resized horizontally and vertically by pushing the left mouse button when the mouse is positioned over the square in the top-left corner of the text object or the square in the top-right corner of the text object or the square in the bottom-left corner of the text object or the square in the bottom-right corner of the text object, dragging the mouse to the new location of the top-left corner of the text object or to the new location of the top-right corner of the text object or to the new location of the bottom-left corner of the text object or to the new location of the bottom-right corner of the text object, depending on which corner was selected, then releasing the left mouse button. The text object can be resized horizontally by pushing the left mouse button when the mouse is positioned over the square in the top-center of the text object or the square in the bottom-center of the text object, dragging the mouse to the new location of the top edge of the text object or to the new location of the bottom edge of the text object, depending on which edge was selected, then releasing the left mouse button. The text object can be resized vertically by pushing the left mouse button when the mouse is positioned over the square in the left-middle of the text object or the square in the right-middle of the text object, dragging the mouse to the new location of the left edge of the text object or to the new location of the right edge of the text object, depending on which edge was selected, then releasing the left mouse button.
k. Moving the text object. A text object is movable when it is selected. When a text object is first created, it is automatically selected. The user can immediately move the text object. The text object can be moved in any direction by pushing the left mouse button when the mouse is positioned on the outer edge but not over the square in any corner or any edge, dragging the mouse to the new location of the text object, then releasing the left mouse button.
l. Deleting the text object. A text object is able to be deleted when it is selected. When a text object is first created, it is automatically selected. The user can immediately delete the text object. The text object can be deleted by clicking the “Delete” toolbar icon (Drawing 18).
m. Selecting a text object. A text object can be selected by clicking on it, or if the “Objects” window is visible (Drawing 11), by clicking the item that corresponds to the text object the user wishes to select. The user knows which item to click by cross-referencing the text of the item to the text of the text object the user wishes to select.
n. Editing the properties of a text object. If the “Objects” window is visible (Drawing 11), the right-clicking on the text object item for which the user wishes to edit the properties will present a context menu (Drawing 19). When the user clicks “Properties” in the context menu a new window will appear (Drawing 20). If a user checks “Expand Left” for “Horizontal Settings,” the text object can be expanded left at the time it is rendered to accommodate text that might exceed the current size of the text object (due to a larger font name, font size, different style (bold, italic, underline), or long text (text in a different language)). If a user checks “Expand Right” for “Horizontal Settings,” the text object can be expanded right at the time it is rendered to accommodate text that might exceed the current size of the text object (due to a larger font name, font size, different style (bold, italic, underline), or long text (text in a different language)). If a user checks “Expand Left and Right” for “Horizontal Settings,” the text object can be expanded left and right (equally) at the time it is rendered to accommodate text that might exceed the current size of the text object (due to a larger font name, font size, different style (bold, italic, underline), or long text (text in a different language)). If a user checks “Shrink Left” for “Horizontal Settings,” the text object can be shrunk from the left at the time it rendered to accommodate text that might be smaller than the current size of the text object (due to a smaller font name, font size, different style (bold, italic, underline), or short text (text in a different language)). If a user checks “Shrink Right” for “Horizontal Settings,” the text object can be shrunk from the right at the time it is rendered to accommodate text that might be smaller than the current size of the text object (due to a smaller font name, font size, different style (bold, italic, underline), or short text (text in a different language)). If a user checks “Shrink Left and Right” for “Horizontal Settings,” the text object can be shrunk from the left and right (equally) at the time it is rendered to accommodate text that might be smaller than the current size of the text object (due to a smaller font name, font size, different style (bold, italic, underline), or short text (text in a different language)). If a user checks “Expand Up” for “Vertical Settings,” the text object can be expanded from the top at the time it is rendered to accommodate text that might exceed the current size of the text object (due to a larger font name, font size, different style (bold, italic, underline), or long text (text in a different language)). If a user checks “Expand Down” for “Vertical Settings,” the text object can be expanded from the bottom at the time it is rendered to accommodate text that might exceed the current size of the text object (due to a larger font name, font size, different style (bold, italic, underline), or long text (text in a different language)). If a user checks “Expand Up and Down” for “Vertical Settings,” the text object can be expanded from the top and bottom (equally) to accommodate text that might exceed the current size of the text object (due to a larger font name, font size, different style (bold, italic, underline), qr long text (text in a different language)). If a user checks “Shrink Up” for “Vertical Settings,” the text object can be shrunk from the top to accommodate text that might be smaller than the current size of the text object (due to a smaller font name, font size, different style (bold, italic, underline), or short text (text in a different language)). If a user checks “Shrink Down” for “Vertical Settings,” the text object can be shrunk from the bottom to accommodate text that might be smaller than the current size of the text object (due to a smaller font name, font size, different style (bold, italic, underline), or short text (text in a different language)). If a user checks “Shrink Up and Down” for “Vertical Settings,” the text object can be shrunk from the top and bottom (equally) to accommodate text that might be smaller than the current size of the text object (due to a smaller font name, font size, different style (bold, italic, underline), or short text (text in a different language)). Only one value can be chosen for Horizontal Expansion. Only one value can be chosen for Horizontal Shrinkage. Only one value can be chosen for Vertical Expansion. Only one value can be chosen for Vertical Shrinkage. If the user clicks the “Cancel” button, the window closes and the properties of the text object are not saved. If the user clicks the “OK” button, the window closes and the properties of the text object are saved.
o. Line objects are added to the image. A line object is created by clicking the “Line Tool” toolbar icon (Drawing 27). The user then pushes the left mouse button down where the line object should start, drags to the location where the line object should stop, then releases the left mouse button, and the line object is created (Drawing 8). The line object is created with the currently selected line style (Drawing 28) and line size (Drawing 29).
p. Editing a line object. A line object is editable when it is selected. When a line object is first created, it is automatically selected. The line style of the line object can be changed by choosing the desired line style from. the line style menu (Drawing 28). The line size of the line object can be changed by choosing the desired line size from the line size menu (Drawing 29).
q. Resizing a line object. A line object is resizable when it is selected. When a line object is first created, it is automatically selected. The user can immediately resize the line object. The line object can be resized horizontally and vertically by pushing the left mouse button when the mouse is positioned over the square in the top-left corner of the line object or the square in the top-right corner of the line object or the square in the bottom-left corner of the line object or the square in the bottom-right corner of the line object, dragging the mouse to the new location of the top-left corner of the line object or to the new location.of the top-right corner of the line object or to the new location of the bottom-left corner of the line object or to the new location of the bottom-right corner of the line object, depending on which corner was selected, then releasing the left mouse button.
r. Moving the line object. A line object is movable when it is selected. When a line object is first created, it is automatically selected. The user can immediately move the line object. The line object can be moved in any direction by pushing the left mouse button when the mouse is positioned on the line but not over the square in any corner, dragging the mouse to the new location of the line object, then releasing the left mouse button.
s. Deleting the line object. A line object is able to be deleted when it is selected. When a line object is first created, it is automatically selected. The user can immediately delete the line object. The line object can be deleted by clicking the “Delete” toolbar icon (Drawing 18).
t. Selecting a line object. A line object can be selected by clicking on it, or if the “Objects” window is visible (Drawing 11), by clicking the item that corresponds to the line object the user wishes to select.
u. Saving the new image. A new image must be saved for the Image Server to be able to render it. A new image is saved by clicking the “Save” button in the toolbar (Drawing 21). At this point, the Image Creator builds an XML representation of the image (Drawing 22) and all the objects (text, line, etc.) it contains, so that it can be rendered by the Image Server. The root node of the XML document (“image”) stores the Width in Pixels of the image in the “width” attribute, the Height in Pixels of the image in the “height” attribute, an integer representation of the Background Color in the “background” attribute, and a bit flag that indicates whether or not the image has been changed since the last save in the “dirtyFlag” attribute. For each object (text, line, etc.) in the image, an element is added to the root node's “objects” node. Each text object node stores its unique identifier in the “id” attribute, its type in the “type” attribute (a way for the Image Server to know what type of object it is at render time), its number in the “number” attribute (a way for the user to know which object it is when specifying its font name, color, size, style (bold, italic, underline), alignment, color to the Image Server), its top position in the “top” attribute, its height in the “height” attribute, it's left position in the “left” attribute, its width in the “width” attribute, and data pertaining to the specifics in the “data” attribute, delimited by a “˜|˜” delimiter. In the event of a text object, the first value of the data attribute identifies the font name, the second value of the data attribute identifies the font size, the third value of the data attribute identifies an integer representation of the font color, the fourth value of the data attribute identifies whether the font style is bold (0 indicates the font is not bold, 1 indicates the font is bold), the fifth value of the data attribute identifies whether the font style is italic (0 indicates the font is not italic, 1 indicates the font is italic), the sixth value of the data attribute identifies whether the font style is underline (0 indicates the font is not underline, 1 indicates the font is underline), the seventh value indicates the font alignment (0 indicates the font is aligned left, 1 indicates the font is aligned center, 2 indicates the font is aligned right), and the eight value of the data attribute identifies the text of the text object. In the event of a line object, the first value of the data attribute identifies the line style, the second value of the data attribute identifies the line size, the third value of the data attribute identifies the line color, and the fourth value of the data attribute identifies which corner the line begins at. After clicking the “Save” toolbar icon, a window named “Save” appears (Drawing 23). The folders visible in the “Folder” tree-view are folders that user has created, information for which has been stored in the database. If the user clicks the “OK” button and has not selected a Folder or not typed an Image Name or typed an Image Name that already exists in the selected folder, a message indicating such is displayed, and the user must make the necessary corrections. If the user clicks the “OK” button and has selected a Folder but typed an Image Name that already exists in the selected folder, a message indicating such is displayed, and the user must make the necessary corrections. If the user clicks the “OK” button and has selected a Folder and typed and Image Name that does not already exist in the selected folder, the window closes and the image is added to the database, associated to the specified Folder. If the user clicks the “Cancel” button the window closes and the image is not added to the database.
v. Opening an image. A previously saved image can be opened and edited, then saved, if desired. To open an image, the user clicks the “Open” toolbar icon (Drawing 24). A new window named “Open” appears (Drawing 25). If the user selects a folder and clicks the “OK” button, a message indicating that an image must be selected is displayed and the user must make the necessary corrections. If the user selects an image and clicks the “OK” button, the window is closed and the image is opened. If the user clicks the “Cancel” button, the window is closed and no image is opened. An image that is opened can be edited and saved the same way a new image can (previously described).
w. Image URL. Once an image has been added to the database, its Image URL is available in the Image URL Window (Drawing 26). The Image URL is how the Image Server is accessed and asked to render an image. Clicking the “Copy” button will copy the Image URL to the user's clipboard and a message indicating such is displayed.

Using the Image Server. A user of the Image Server will use it in one of, but not limited to, the following ways: a) via a web browser, pasting the Image URL into the text-box next to “Address” and pressing the “Enter” or “Return” key, then copying the rendered image to the user's clipboard, and then pasting the clipboard contents into any medium that supports pasting images from the user's clipboard (word processing document, spreadsheet, etc.), b) using the Image URL as the source of an image in a dynamically rendered or static HTML page. For the sake of demonstrating how the Image Server is used, the latter approach of using the Image URL as the source of an image in a static HTML page will be used.
a. The Image URL from the image created in the Image Creator demonstration is:
http://www.nervology.com/ImageCreator/Server.aspx?function=8&imageID=23&background=%23FF FFFF&2_Style=Solid&2_Size=1&2_Color=%23000000&1_Font=Arial&1_Size=10&1_Color=%23000000&1_Bold=0&1_Italic=0&1_Underline=0&1_Align=0&1_Text=Image+Creator

The Image URL queries the Image Server, passing it parameters used to render the image, as follows:

| | | |
|---|---|---|
| function | 8 | Instructs the Image Server to render an image |
| imageID | 23 | Instructs the Image Server to load from the |
| | | database the XML representation of the image |
| | | with imageID equal to 23 |
| background | #FFFFFF | Instructs the Image Server to paint the |
| | | background of the dynamically rendered image |
| | | with a white color |
| 2_Style | Solid | Instructs the Image Server to paint the object |
| | | with a number of 2 (in this case, the line |
| | | object) with a solid brush |
| 2_Size | 1 | Instructs the Image Server to paint the object |
| | | with a number of 2 (in this case, the line |
| | | object) with a brush width of 1 pixel |
| 2_Color | #000000 | Instructs the Image Server to paint the object |
| | | with a number of 2 (in this case, the line |
| | | object) with a black color |
| 1_Font | Arial | Instructs the Image Server to paint the object |
| | | with a number of 1 (in this case, the text |
| | | object) with an Arial font |
| 1_Size | 10 | Instructs the Image Server to paint the object |
| | | with a number of 1 (in this case, the text |
| | | object) with a font size of 10 points |
| 1_Color | #000000 | Instructs the Image Server to paint the object |
| | | with a number of 1 (in this case, the text |
| | | object) with a black color |
| 1_Bold | 0 | Instructs the Image Server to paint the object |
| | | with a number of 1 (in this case, the text |
| | | object) without a bold style. If the value was 1 |
| | | instead of 0, the object would be painted with a |
| | | bold style |
| 1_Italic | 0 | Instructs the Image Server to paint the object |
| | | with a number of 1 (in this case, the text |
| | | object) without an italic style. If the value was |
| | | 1 instead of 0, the object would be painted with |
| | | an italic style |
| 1_Underline | 0 | Instructs the Image Server to paint the object |
| | | with a number of 1 (in this case, the text |
| | | object) without an underline style. If the value |
| | | was 1 instead of 0, the object would be painted |
| | | With an underline style. |
| 1_Align | 0 | Instructs the Image Server to paint the object |
| | | with a number of 1 (in this case, the text |
| | | object) with a left alignment. If the value was 1 |
| | | instead of 0, the object would be painted with a |
| | | center alignment. If the value was 2 instead of |
| | | 0, the object would be painted with a right |
| | | alignment. |
| 1_Text | Image | Instructs the Image Server to paint the object |
| | Creator | with a number of 1 (in this case, the text |
| | | object) with a text value of Image Creator. |

At a minimum, the Image URL must contain parameter values for the “function” parameter and the “imageID” parameter. All other parameters are optional, and are used when the user wishes to render an image that is different from the original image. For example, the following Image URL will paint the object with a number of 1 (in this case, the text object) with the font the user specified when creating the image (in this case, “Arial.”):
http:/lwww. nervology.com/ImageCreator/Server.aspx?function=8&imageID=23
   Alternatively, the following Image URL will paint the object with a number of 1 (in this case, the text object) with the font the user specifies in the Image URL (“Tahoma”) rather than the font the user specified when creating the image (“Arial”):
http:/lwww. nervology.com/ImageCreator/Server.aspx?function=8&imageID=23&1_Font=Tahoma
   In summary, when parameter values are specified, the image is painted with the parameter values. When parameter values are not specified, the image is painted with the values specified when the user created the image.
   b. To use the Image URL as the source of an image in a static HTML page, a user would create a new static HTML page in which the image is to be displayed, or open an existing static HTML page in which the image is to be displayed. For the sake of this demonstration, the first approach of creating a new static HTML page in which the image is to be displayed will be used. Click the “Start” button. Click “All Programs.” Click “Accessories.” Click “Notepad.” In the new window that appears, type the following text:
<html>
<body>
<img src=“
http://www. nervology.com/ImageCreator/Server.aspx?function=8&imagel D=23&background=%23FF FFFF&2_Style=Solid&2_Size=1 &2_Color=%23000000&1_Font=Arial&1_Size=10&1_Color=%23000000&1_Bold=0&1_Italic=0&1_Underline=0&1_Align=0&1_Text=Image+Creator”>
</body>
</html>

Click the “File” menu. In the menu that appears, click “Save.” A new window will appear. Type “Image1.html” into the text-box next to “File name.” Choose “All Files” from the drop-down next to “Save as type.” Click the “Save” button. Open “Image1.html” in Microsoft Internet Explorer. Microsoft Internet Explorer, as it renders the HTML page, recognizes the “img” tag as a command to display an image, and recognizes the “src” attribute of the “img” tag as containing a value speciflying the location of the image to display. Microsoft Internet Explorer then makes a request to the value of the “src” attribute of the “img” tag, in this case, the following URL: http:l/www.nervology.com/ImageCreator/Server.aspx?function=8&imagel D=23&background=%23FF FFFF&2_Style=Solid&2_Size=1&2_Color=%23000000&1_Font=Arial&1_Size=10&1_Color=%23000000&1_Bold=0&1_Italic=0&1_Underline=0&1_Align=0&1_Text=Image+Creator

“Server.aspx” is a server-side script, and is the entry point to the Image Server software. The server- side script could be in any folder, on any server, depending on installation specifics (i.e., if the software is hosted by Nervology or a third party, or if the location of the software is in its default location or an alternate location).

Below is a step-by-step process of how the request to render a dynamic image is processed:
a. “Server.aspx” reads the parameter values, and sends them to the Image Server software.
b. The Image Server looks for a value for the “function” parameter. In this case, the value is “8” and the Image Server recognizes the value as an instruction to render an image.
c. The Image Server looks for a value for the “imagelD” parameter. In this case, the value is “23” and the Image Server makes a request to the database for the XML representation of the image with an “imagelD” equal to “23.”
d. The Image Server analyzes the contents of the XML representation (Drawing 22).
e. The Image Server retrieves the value for the “width” attribute of the root node (“image” node) and determines that the width in pixels of the image will be 150.
f. The Image Server retrieves the value for the “height” attribute of the root node (“image” node) and determines that the height in pixels of the image will be 150.
g. The Image Server retrieves the value for the “background” attribute of the root node (“image” node) and determines that the image was created with a background color having a numeric representation of “−1”, which equates to an HTML representation of “#FFFFFF.” The Image Server then looks to see if a value for the “background” parameter was specified. In this case a value of “#FFFFFF” was specified. If the value was not specified, the Image Server would paint the image with the background color specified in the XML representation. Since the value was specified, even though, in this case, it is not different from that specified in the XML representation, the Image Server will paint the image with the background color specified in the parameter.
h. Because the “top” and “left” attributes of each “objects/object” node of the root node (“image” node) are in relation to the Image Creator control, the Image Server creates an image in memory, having the same height (570 pixels) and width (760 pixels) as the Image Creator, and a background color of white. Once drawing is complete, the Image Server will “extract” a 150 pixel wide by 150 pixel high rectangle from the image starting at the top and left positions the image occupied when the user created the image.
i. The Image Server then iterates through each “objects/object” node of the root node (“image” node). In the case of the XML representation (Drawing 22), there are two “objects/object” nodes of the root node (“image” node).

Processing the first “objects/object” node of the root node (“image” node):

The contents of the first “objects/object” node of the root node (“image” node) are as follows:
<object id=“a3a0fa59-aa50-4642-b3d8-45a57e7378a6” number=“2” type=“2” top=“288” height=“63”left=“339” width=“81” data=“Solid˜|˜1˜|˜−16777216˜|˜3” />

The Image Server first checks the value for the “type” attribute. This value tells the Image Server what type of object it will be adding to the image. In this case, the value is “2” which indicates a line object.

The Image Server then checks the value for the “number” attribute. This value tells the Image Server which parameters correspond to this particular object. Parameters with a name beginning with the value for the “number” attribute and an underscore character (“_”) apply to this object. The Image Server retrieves the first value of the “data” attribute from the XML representation and determines that the object was created with a line style of “Solid.” It then checks for a value for the “2_Style” parameter. In this case, a value of “Solid” was specified. If the value was not specified, the Image Server would paint the object with the line style specified in the XML representation. Since the value was specified, even though, in this case, it is not different from that specified in the XML representation, the Image Server will paint the object with the line style specified in the parameter. The Image Server retrieves the second value of the “data” attribute from the XML representation and determines that the object was created with a line size of “1.” It then checks for a value for the “2_Size” parameter. In this case, a value of “1” was specified. If the value was not specified, the Image Server would paint the object with the line size specified in the XML representation. Since the value was specified, even though, in this case, it is not different from that specified in the XML representation, the Image Server will paint the object with the line size specified in the parameter. The Image Server retrieves the third value of the “data” attribute from the XML representation and determines that the object was created with a line color having a numeric representation of “−16777216”, which equates to an HTML representation of “#000000.” It then checks for a value for the “2_Color” parameter. In this case, a value of “#000000” was specified. If the value was not specified, the Image Server would paint the object with the line color specified in the XML representation. Since the value was specified, even though, in this case, it is not different from that specified in the XML representation, the Image Server will paint the object with the line color specified in the parameter. The Image Server retrieves the fourth value of the “data” attribute from the XML representation and, because the value is “3,” determines that the object was created by drawing the line from the bottom-left corner to the top-left corner. Had a value of “1” been specified, the Image Server would have determined that the object was created by drawing the line from the top-left corner to the bottom-right corner. Had a value of “2” been specified, the Image Server would have determined that the object was created by drawing the line from the top-right corner to the bottom-left corner. Had a value of “4” been specified, the Image Server would have determined that the object was created by drawing the line from the bottom-right corner to the top-left corner.

The Image Server retrieves the value for the “top” attribute from the XML representation and determines that the top of the line is at the 288^{th} pixel. The Image Server retrieves the value for the “left” attribute from the XML representation and determines that the left of the line is at the 339^{th} pixel. The Image Server retrieves the value for the “height” attribute from the XML representation and determines that the height of the line is 63 pixels. The Image Server retrieves the value for the “width” attribute from the XML representation and determines that the width of the line is 81 pixels. The Image Server then draws a solid, 1 pixel size, black line starting at an (X, Y) pixel coordinate of (339, 288) and having a height of 63 pixels and a width of 81 pixels.

Processing the second “objects/object” node of the root node (“image” node):

The contents of the first “objects/object” node of the root node (“image” node) are as follows: <object id=“f7d60e9d-294f-4cde-90ee−299751b0e231” number=“1” type=“1” top=“234” height=“55”left=“317” width=“142” data=“Arial˜|˜10˜|˜−16777216˜|˜0˜|˜0˜|˜0˜|˜0˜|˜Image Creator” />

The Image Server first checks the value for the “type” attribute. This value tells the Image Server what type of object it will be adding to the image. In this case, the value is “1” which indicates a text object.

The Image Server then checks the value for the “number” attribute. This value tells the Image Server which parameters correspond to this particular object. Parameters with a name beginning with the value for the “number” attribute and an underscore character (“_”) apply to this object.

The Image Server retrieves the first value of the “data” attribute from the XML representation and determines that the object was created with a font name of “Arial.” It then checks for a value for the “1_Font” parameter. In this case, a value of “Arial” was specified. If the value was not specified, the Image Server would paint the object with the font name specified in the XML representation. Since the value was specified, even though, in this case, it is not different from that specified in the XML representation, the Image Server will paint the object with the font name specified in the parameter. The Image Server retrieves the second value of the “data” attribute from the XML representation and determines that the object was created with a font size of “10.” It then checks for a value for the “1_Size” parameter. In this case, a value of “10” was specified. If the value was not specified, the Image Server would paint the object with the font size specified in the XML representation. Since the value was specified, even though, in this case, it is not different from that specified in the XML representation, the Image Server will paint the object with the font size specified in the parameter.

The Image Server retrieves the third value of the “data” attribute from the XML representation and determines that the object was created with a font color having a numeric representation of “−16777216”, which equates to an HTML representation of “#000000.” It then checks for a value for the “1_Color” parameter. In this case, a value of “#000000” was specified. If the value was not specified, the Image Server would paint the object with the font color specified in the XML representation.

Since the value was specified, even though, in this case, it is not different from that specified in the XML representation, the Image Server will paint the object with the font color specified in the parameter.

The Image Server retrieves the fourth value of the “data” attribute from the XML representation and determines that the object was created with a font style of “0” or “not bold.” It then checks for a value for the “1_Bold” parameter. In this case, a value of “0” was specified. If the value was not specified, the Image Server would paint the object with the font style specified in the XML representation. Since the value was specified, even though, in this case, it is not different from that specified in the XML representation, the Image Server will paint the object with the font style specified in the parameter. The Image Server retrieves the fifth value of the “data” attribute from the XML representation and determines that the object was created with a font style of “0” or “not italic.” It then checks for a value for the “1_Italic” parameter. In this case, a value of “0” was specified. If the value was not specified, the Image Server would paint the object with the font style specified in the XML representation. Since the value was specified, even though, in this case, it is not different from that specified in the XML representation, the Image Server will paint the object with the font style specified in the parameter.

The Image Server retrieves the sixth value of the “data” attribute from the XML representation and determines that the object was created with a font style of “0” or “not underline.” It then checks for a value for the “1_Underline” parameter. In this case, a value of “0” was specified. If the value was not specified, the Image Server would paint the object with the font style specified in the XML representation. Since the value was specified, even though, in this case, it is not different from that specified in the XML representation, the Image Server will paint the object with the font style specified in the parameter.

The Image Server retrieves the seventh value of the “data” attribute from the XML representation and determines that the object was created with a font alignment of “0” or “left.” It then checks for a value for the “1_Align” parameter. In this case, a value of “0” was specified. If the value was not specified, the Image Server would paint the object with the font alignment specified in the XML representation. Since the value was specified, even though, in this case, it is not different from that specified in the XML representation, the Image Server will paint the object with the font alignment specified in the parameter.

The Image Server retrieves the eigth value of the “data” attribute from the XML representation and determines that the object was created with a text value of “Image Creator.” It then checks for a value for the “1_Text” parameter. In this case, a value of “Image Creator” was specified. If the value was not specified, the Image Server would paint the object with the text value specified in the XML representation. Since the value was specified, even though, in this case, it is not different from that specified in the XML representation, the Image Server will paint the object with the text value specified in the parameter.

If the values specified in the Image URL query attributes caused the text to exceed the length of the text object, and the user had set the properties of the text object to allow the text object to expand left, the text object would be expanded left until the text fit. If the values specified in the Image URL query attributes caused the text to exceed the length of the text object, and the user had set the properties of the text object to allow the text object to expand right, the text object would be expanded right until the text fit. If the values specified in the Image URL query attributes caused the text to exceed the length of the text object, and the user had set the properties of the text object to allow the text object to expand left and right, the text object would be expanded left and right (equally) until the text fit.

If the values specified in the Image URL query attributes caused the text to fall short of the length of the text object, and the user had set the properties of the text object to allow the text object to shrink left, the text object would be shrunk left until the text fit. If the values specified in the Image URL query attributes caused the text to fall short of the length of the text object, and the user had set the properties of the text object to allow the text object to shrink right, the text object would be shrunk right until the text fit. If the values specified in the Image URL query attributes caused the text to fall short of the length of the text object, and the user had set the properties of the text object to allow the text object to shrink left and right, the text object would be shrunk left and right (equally) until the text fit.

If the values specified in the Image URL query attributes caused the text to exceed the height of the text object, and the user had set the properties of the text object to allow the text object to expand up, the text object would be expanded up until the text fit. If the values specified in the Image URL query attributes caused the text to exceed the height of the text object, and the user had set the properties of the text object to allow the text object to expand down, the text object would be expanded down until the text fit. If the values specified in the Image URL query attributes caused the text to exceed the height of the text object, and the user had set the properties of the text object to allow the text object to expand up and down, the text object would be expanded up and down (equally) until the text fit.

If the values specified in the Image URL query attributes caused the text to fall short of the height of the text object, and the user had set the properties of the text object to allow the text object to shrink up, the text object would be shrunk up until the text fit. If the values specified in the Image URL query attributes caused the text to fall short of the height of the text object, and the user had set the properties of the text object to allow the text object to shrink down, the text object would be shrunk down until the text fit. If the values specified in the Image URL query attributes caused the text to fall short of the height of the text object, and the user had set the properties of the text object to allow the text object to shrink up and down, the text object would be shrunk up and down (equally) until the text fit.

The Image Server retrieves the value for the “top” attribute from the XML representation and determines that the top of the line is at the 234^{th} pixel. The Image Server retrieves the value for the “left” attribute from the XML representation and determines that the left of the line is at the 317^{th} pixel. The Image Server retrieves the value for the “height” attribute from the XML representation and determines that the height of the line is 55 pixels. The Image Server retrieves the value for the “width” attribute from the XML representation and determines that the width of the line is 142 pixels. The Image Server then draws the text “Image Creator” having a font of Arial, having a size of 10 points, having a color of black, having a style of not bold, having a style of not italic, having a style of not underline, and having an alignment of left.

Because the objects were drawn on an image that is the width and height of the Image Creator (760 pixels wide and 570 pixels high), the Image Server “extract” a 150 pixel wide by 150 pixel high rectangle from the image starting at the top and left positions the image occupied when the user created the image.

Lastly, as the response to Microsoft Internet Explorer's request for the image, the Image Server writes a value for the “Content-Type” header to the web server's response stream. The actual value depends on what format the image has been rendered in. For an image in GIF format, the value “image/gif” would be written as the value for the “Content-Type” header. For an image in JPG format, the value “image/jpeg” would be written as the value for the “Content-Type” header. Then, the binary data of the extracted rectangle is written to the web server's response stream. Microsoft Internet Explorer displays the image on the web page.

Before this invention, if a user had an image that contained the text “Image Creator” with a font name of Arial and a font size of 10, and the user wanted the image to contain the text “Image Server” with a font name of “Tahoma” and a font size of 12, the user would have to create a copy of the image, make the necessary changes, then either overwrite the original image or save the modified image as a separate entity.

With this invention, a user can create one image, and display it different ways simply by specifying parameter values in the Image URL used to retrieve the image from the Image Server.

1. The overall methodology and system of creating, editing, saving, or otherwise manipulating a document as a collection of separately customizable objects, including, without limitation, text objects and line objects, providing a user a way to request the document, including, without limitation, a URL (Uniform Resource Locator), and enabling, but not requiring, a user to specify values for the configurable properties of each object, including, without limitation, font name, font size, font color, font style (bold, italic, underline), font alignment, text displayed, line style, line size and line color, and enabling, but not requiring, a user to specify which objects or which sections of the document can expand or shrink to accommodate objects that exceed or fall short of their predefined size (due to values specified for the configurable properties), and, in response to a user's request for a document, and taking into account the way the document was originally created and the values, if any, the user specifies for the configurable properties of each object, render the document and provide it in a format including, without limitation, a visual or electronic representation.
